(19) United States
(12) Patent Application Publication
(10) Pub. No.: US 2025/0155327 A1
(43) Pub. Date: May 15, 2025

(54) METHODS AND APPARATUS TO IMPLEMENT SAFETY DIAGNOSTICS

(71) Applicant: Texas Instruments Incorporated, Dallas, TX (US)

(72) Inventors: Anand Kumar G, Bangalore (IN); Veeramanikandan Raju, Bangalore (IN)

(21) Appl. No.: 18/508,889

(22) Filed: Nov. 14, 2023

(51) Int. Cl. G01M 99/00

(52) U.S. Cl. CPC G01M 99/00

(57) ABSTRACT

An example apparatus includes: interface circuitry; and diagnostic circuitry configured to: determine a set of signal chains that may be used by an application, a signal chain in the set to include an ordered sequence of one or more circuit modules; identify a first signal chain from the set that was used by the application; and run, in response to a determination that the circuit modules in the first signal chain are idle, a diagnostic test on the first signal chain.

### TECHNICAL FIELD

This description relates generally to processors, and, more particularly, to methods and apparatus to implement safety diagnostics.

### BACKGROUND

The architecture of a processor may be described as a group of modules. In such an architecture, the processor performs operations by sending electrical signals to one or more modules within the group. A given processor may include a wide variety of modules. For example, modules can vary in cost, complexity, performance, function, and other characteristics. Some industries may use diagnostic tests to evaluate whether a processor meets performance and/or safety standards. Generally, a diagnostic test includes providing an input to a sequence of modules and comparing the output of the sequence to an expected value.

### SUMMARY

For methods and apparatus to implement safety diagnostics, an example apparatus includes interface circuitry; and diagnostic circuitry configured to: determine a set of signal chains that may be used by an application, a signal chain in the set to include an ordered sequence of one or more circuit modules; identify a first signal chain from the set that was used by the application; and run, in response to a determination that the circuit modules in the first signal chain are idle, a diagnostic test on the first signal chain.

### BRIEF DESCRIPTION OF THE DRAWINGS

FIG. 1 is a block diagram of an example environment including a processor and an application.

FIG. 2 is a block diagram of an example implementation of the Hardware Safety Diagnostics Engine of FIG. 1.

FIG. 3A is a block diagram of an example implementation of the system timer of FIG. 1.

FIG. 3B is a block diagram of an example implementation of the rate determiner circuitry 208 of FIG. 2.

FIG. 4 are block diagrams of example implementations of signal chains.

FIG. 5 is a flowchart representative of example operations that may be executed, instantiated, and/or performed using an example programmable circuitry implementation of the Hardware Safety Diagnostics Engine of FIG. 1.

FIG. 6 is a flowchart representative of example machine readable instructions and/or example operations that may be executed, instantiated, and/or performed using example programmable circuitry to diagnose a selected signal chain as discussed in connection with FIG. 5.

FIG. 7 is a block diagram of an example processing platform including programmable circuitry structured to execute, instantiate, and/or perform the example machine readable instructions and/or perform the example operations of FIGS. 5 and 6 to implement the HSDE circuitry of FIG. 2.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Diagnostic tests of processors are generally implemented in software. For example, an application may include machine-readable instructions (e.g., code) that provides an input value to a processor, requests the output value, and compares the output to an expected value. The execution of such software driven tests require data to traverse across multiple layers of the Open Systems Interconnection (OSI) model. This data traversal adds latency that negatively impacts the performance of an application whenever a test is run. This latency can become a compounded issue when diagnostic tests are implemented during both boot-up periods (e.g., periods when devices are powering on and connecting to systems) and run-time (e.g., periods when the processor is implementing an application).

To perform a software-based diagnostic at run-time, an application implementing the test may request knowledge of which modules are currently being utilized by the processor and which modules are currently idle. Implementing such logic may: add complexity to the software, add size to the code base, increase the duration of testing cycles, and increase power consumption of the processor.

In some examples, an application running test software-based diagnostic may be unable to determine which modules are active and which modules are idle during run-time. In such an example, the software-based diagnostic test may blindly test all modules in a processor to ensure safety because it is unclear which modules are being used at run-time. Such diagnostic tests are inefficient and introduce additional latency by testing modules that are not being used.

Example methods, apparatus, and systems described herein implement a technique to perform diagnostic tests that is application context aware, time, cost, and power efficient, software agnostic, helps ensure safety, and can be performed at run-time. Example Hardware Safety Diagnostics Engine (HSDE) circuitry is a hardware module implemented within a processor in accordance with the teachings of this disclosure. The example HSDE circuitry identifies which diagnostic tests may be potentially useful at run-time based on the modules present in the processor. The HSDE circuitry also continuously keeps track of which modules are utilized by an application during run-time. If within a user defined test window, the HSDE identifies a set of modules that: a) can be analyzed with a diagnostic test and b) were previously used by the application but are all currently idle, the HSDE circuitry will initiate the diagnostic test. The HSDE circuitry may complete the diagnostic test and provide the results to the application if time allows. Alternatively, if a time critical application interrupts to reclaiming one of the modules before the diagnostic test is complete, the HSDE circuitry may abandon the former test and initiate a new diagnostic test with other modules that are currently idle. Alternatively, if an application requests access to a module but is willing to wait for a period, the HSDE circuitry may complete the current diagnostic test before returning control of the module to the application.

Advantageously, the example HSDE can implement diagnostic tests in hardware and without assistance or coordination from a software program. Accordingly, the HSDE exhibits less latency, power consumption, and complexity than software-based diagnostic tests by avoiding the traversal of data across multiple layers of the OSI model.

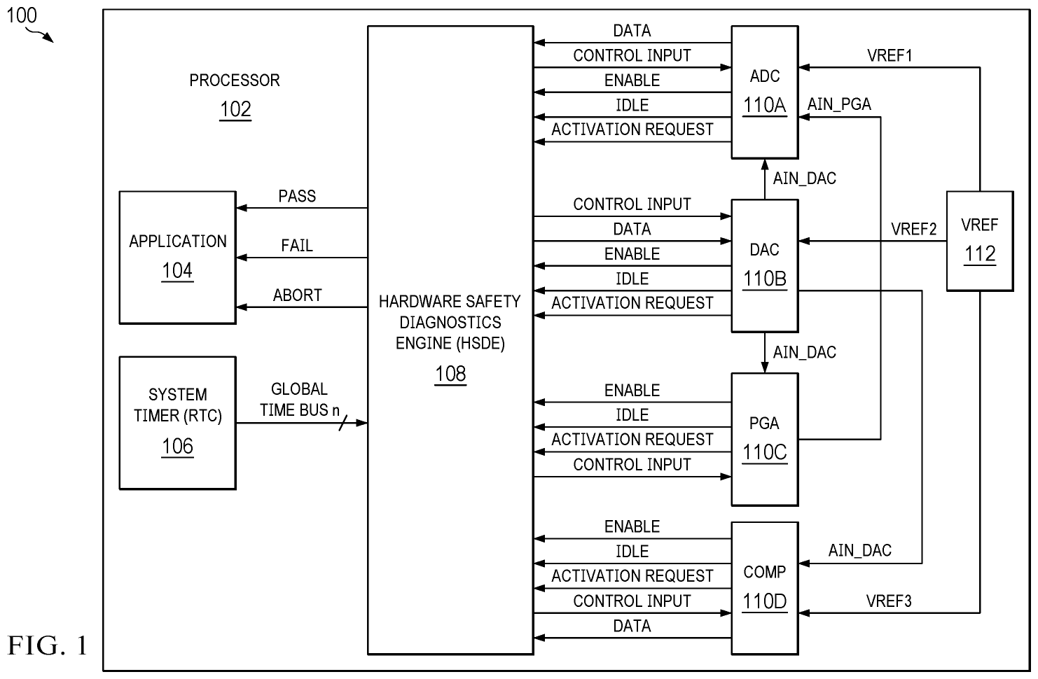

FIG. 1 is a block diagram of an example environment 100 including an example processor 102. The example processor 102 includes an example application 104, example system timer circuitry 106, example HSDE circuitry 108, an example Analog to Digital Converter (ADC) 110A, an example Digital to Analog Converter (DAC) 110B, an example programmable gain amplifier (PGA) 110C, an example comparator (COMP) 110D, and example reference voltage (VREF) circuitry 112. The ADC 110A, the DAC 110B, the PGA 110C, and the COMP 110D may collectively be referred to as example modules 110. Although FIG. 1 depicts processor 102 as including HSDE 108, modules 110, and VREF circuitry 112, one or more of these elements may be located partially or fully outside of processor 102 in some examples. For example, HSDE 108, modules 110, and VREF circuitry 112 may be separate from and coupled to processor 102 in some examples.

The example processor 102 of FIG. 1 performs operations based on the application 104. The processor 102 may be implemented by any form of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). In some examples, processor 102 may include more than processor, e.g., processor 102 may include multiple processing cores.

The example application 104 of FIG. 1 represents machine-readable instructions that cause one or more of the modules 110 within the processor 102 to perform operations in a logical sequence. The application 104 may implement any type of program and provide any sort of functionality. As used herein, the period in which the application 104 causes the modules 110 to perform operations may be referred to as run-time. In some examples, the machine-readable instructions that implement the application 104 are stored in the same device that implements the processor 102. In other examples, the machine-readable instructions are stored separately from the device that implements the processor 102. The example environment 100 of FIG. 1 includes one instance of the application 104. In other examples, a different number of applications communicate cause the processor 102 to perform operations.

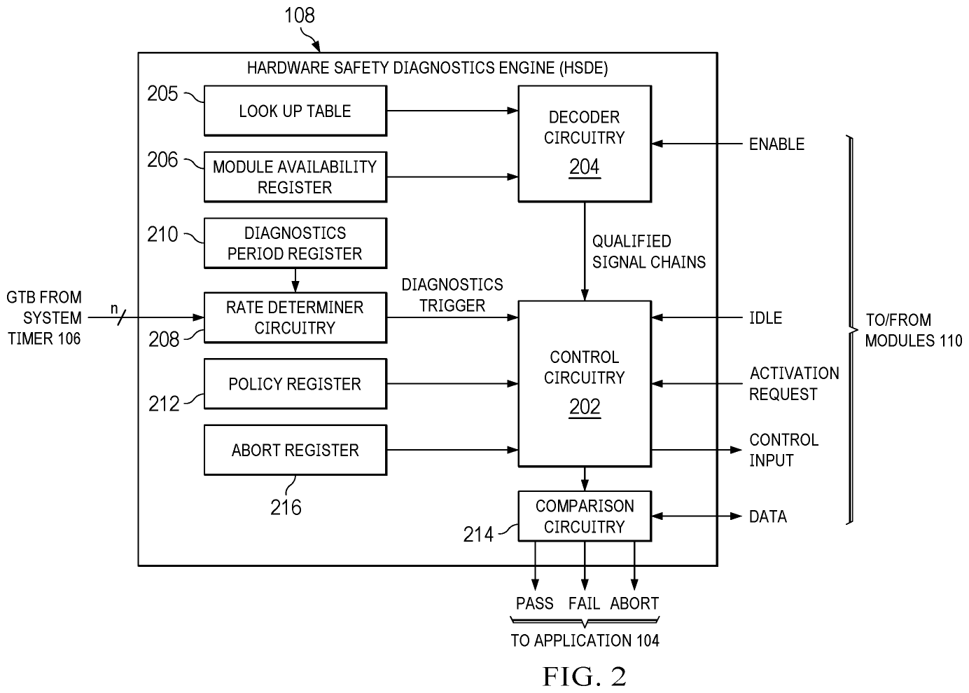

The example system timer circuitry 106 generates a series of clock signals that may be utilized globally throughout the processor 102. In the example of FIG. 1, the HSDE circuitry 108 and the modules 110 may use one or more of the global clock signals to coordinate and/or synchronize operations. The system timer circuitry 106 may be implemented using any type of oscillator or other clock generation circuits. The system timer circuitry 106 is discussed further in connection with FIG. 2. In some examples, the global clock signals may be collectively referred to as a global time bus.

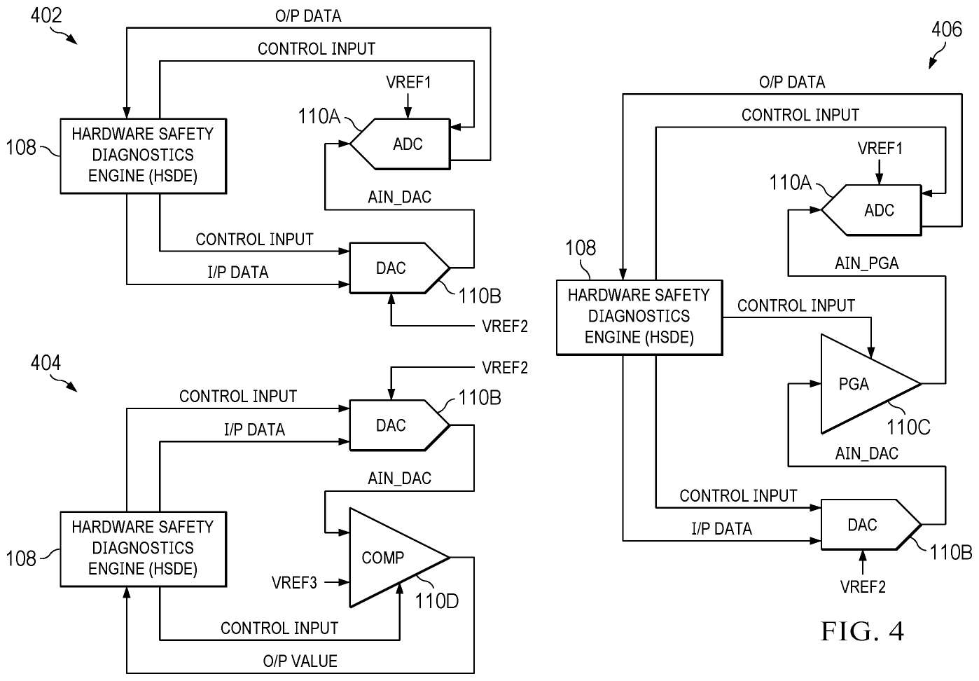

The example HSDE circuitry 108 of FIG. 1 runs diagnostic tests on the modules 110 in accordance with the teachings of this disclosure. To do so, the HSDE circuitry 108 identifies a signal chain ready for a diagnostic test, provides a value in a control input signal to the first module in the signal chain, and obtains a value from a data signal output from the last module in signal chain. As used herein, a signal chain refers to an ordered sequence of one or more modules 110 whose performance can be analyzed with a diagnostic test. Signal chains are discussed further in connection with FIG. 4. In some examples, the HSDE circuitry may be referred to as diagnostic circuitry.

After providing a value in the control input signal, the HSDE circuitry 108 compares the value from the obtained data signal to an expected value. If the obtained data value matches the expected value, the HSDE circuitry 108 informs the application that the signal chain passed the diagnostic test. Alternatively, if the obtained data value does not match the expected value, the HSDE circuitry 108 informs the application that the signal chain failed the diagnostic test. In some examples, the HSDE circuitry 108 instructs the application to abort a set of operations. The HSDE circuitry 108 may provide an abort instruction in examples where a signal chain fails a diagnostic test and the failure is indicative of a safety issue. The HSDE circuitry 108 is discussed further in connection with FIG. 2.

The modules 110 of FIG. 1 are circuit components within the processor 102. The circuit components of modules 110 may be reusable circuit components such as peripheral components, radio frequency transmit or receive components, analog modules, digital modules, and/or software modules. During run-time, some of the modules (e.g., the ADC 110A and the PGA 110C) may perform operations based on input signals provided by the application 104 while different modules (e.g., the DAC 110B and the COMP 110D) concurrently perform operations based on control inputs signals from the HSDE circuitry 108. The processor 102 may implement any number of modules. For example, FIG. 1 illustrates four of the modules 110. The example of FIG. 1 also illustrates modules 110 that perform analog functions. In some examples, the modules 110 include circuits that execute machine-readable instructions to implement digital logic. Such modules may be referred to as Intellectual Property (IP) cores.

In the example of FIG. 1, a given module (e.g., the ADC 110A) receives a control input signal from the HSDE circuitry 108 and outputs a data signal to the HSDE circuitry 108 as discussed above. The respective modules 110 also provide an enable signal, an idle signal, and an activation request signal to the HSDE circuitry 108.

The enable signal produced by a module provides a binary indication of when the module is performing operations for the application 104. For example, a high supply voltage in the enable signal of the ADC 110A may indicate that the ADC 110A is currently being used by the application 104, while a low supply voltage in the enable signal may indicate the ADC 110A is not currently being used by the application 104.

In the example of FIG. 1, the idle signal produced by a module is an inverse of the enable signal. That is, the idle signal of FIG. 1 provides a binary indication of when the module is not performing operations for the application 104. For example, a high supply voltage in the idle signal of the ADC 110A may indicate that the ADC 110A is not currently being used by the application 104, while a low supply voltage in the idle signal may indicate the ADC 110A is being used by the application 104 (e.g., is busy). In examples where the processor 102 communicates with multiple applications, an idle signal may provide a binary indication of when a corresponding module is not performing operations for any of the multiple applications. In some examples, the enable signal line and the idle signal line for each module 110 may be combined into a single line. In such examples, the combined single line can indicate whether the respective module is or is not performing operations for the application 104.

The example VREF circuitry 112 of FIG. 1 produces reference voltages that may be used by one or more of the modules 110 to perform operations. The VREF circuitry 112 may produce any number of reference signals at any voltage. In the example of FIG. 1, the VREF circuitry 112 provides three different reference voltages to the ADC 110A, the DAC 110B, and the COMP 110D. In other examples, the VREF circuitry 112 may provide different values and/or connect to different ones of the modules 110.

The example environment 100 illustrates how the application 104 may initiate the execution of a function and receive updates regarding the safety and performance of the function throughout run-time. Advantageously, the HSDE circuitry 108 implements diagnostic tests independently from the application 104 or any other software program. Accordingly, the decision to run a diagnostic test and the subsequent period during which the modules in a signal chain are unavailable for other applications occur in the example processor 102 with less latency than software-based diagnostic tests where data traverses across multiple OSI layers to perform similar functions.

FIG. 2 is a block diagram of an example implementation of the HSDE circuitry 108 of FIG. 1 to perform diagnostics tests. The HSDE circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured perform operations. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. The example HSDE circuitry 108 of FIG. 2 includes example control circuitry 202, example decoder circuitry 204, an example look up table (LUT) 205, an example module availability register 206, example rate determiner circuitry 208, an example diagnostics period register 210, an example policy register 212, example comparison circuitry 214, and an example abort register 216.

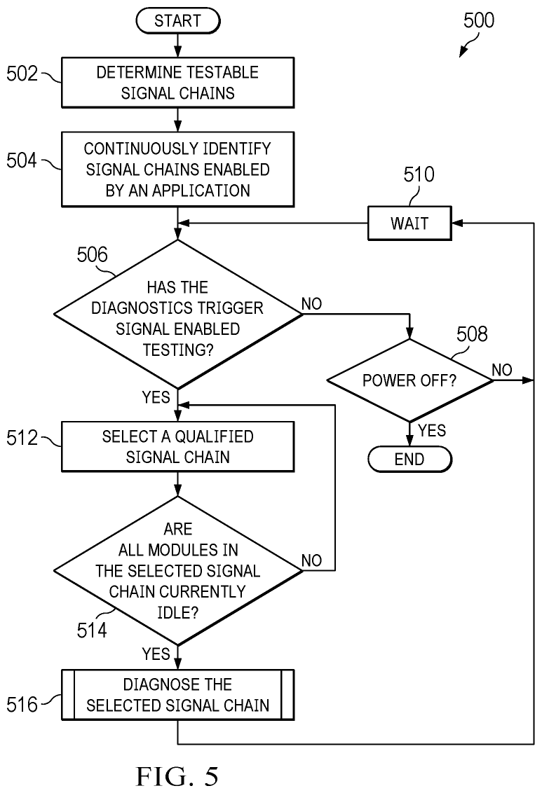

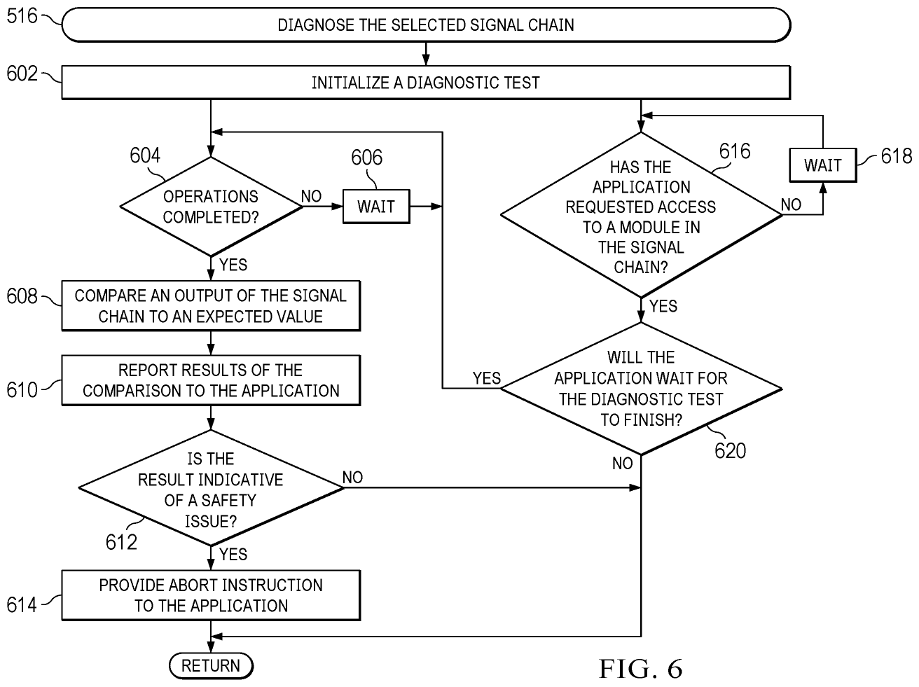

The example control circuitry 202 of FIG. 2 determines when to implement a diagnostic test, initiates the test on a signal chain, determines when to stop the test, and determines what information should be reported to the application 104. To do so, the control circuitry 202 receives the idle signals from the modules 110, receives the activation request signals from the modules 110, receives internal signals from the decoder circuitry 204 and the rate determiner circuitry 208, and accesses data stored in the policy register 212 and the abort register 216. The control circuitry 202 also outputs the control input signals to the modules 110 and configures the comparison circuitry 214 to perform operations. In some examples, the control circuitry 202 implements a state machine to manage the relationship between the plurality of input signals and output signals. In some examples, the control circuitry 202 is instantiated by programmable circuitry configured to perform operations such as those represented by the flowchart(s) of FIGS. 5 and 6.

The control circuitry 202 may only consider a signal chain for diagnostic testing if the signal chain is qualified. Accordingly, the example decoder circuitry 204 of FIG. 2 qualifies signal chains in accordance with the teachings of this disclosure. As used herein, a qualified signal chain refers to a signal chain that has been used at least once by the application 104 during run-time.

To determine which signal chains should be qualified, the decoder circuitry 204 first uses the LUT 205 and module availability register 206 to determine which signal chains are capable of implementation in the example environment 100 of FIG. 1. The LUT 205 refers to a data structure in the memory of the HSDE circuitry 108 that contains a set (e.g., list) of signal chains The HSDE 108 may be configured to maintain the list of signal chains in a dynamic manner at run time based on usage of the modules 110 in the application 104. That is, the LUT 205 stores a plurality of entries where each entry is a different ordered sequence of modules that may be tested on a device. The LUT 205 may be implemented as a pre-determined, static data structure that includes signal chains with modules that are not implemented in the processor 102. In examples described herein, the application 104 runs on the processor 102 and therefore is limited to using signal chains in which the referenced modules are implemented in the environment 100 of FIG. 1 (e.g., implemented in or connected to the processor 102).

The example module availability register 206 of FIG. 2 refers to a data structure in memory that describes the type and quantity of the modules 110 within the environment 100 of FIG. 1. The decoder circuitry 204 uses the module availability register 206 to remove signal chains containing modules not in the processor 102 from consideration for qualification.

For example, suppose the environment 100 of FIG. 1 only includes an ADC, a DAC, and comparator. In such an example, the decoder circuitry 204 may identify the signal chains [ADC+DAC] and [DAC+COMP] within the LUT 205 as potential candidates for qualification. The LUT 205 does not include a [ADC+COMP] signal chain because the ADC produces a digital output and the comparator accepts an analog input. Accordingly, such an ordered sequence of modules is not operational, would not be used by the application 104, and does not need to be tested. If the environment 100 then integrates a PGA, the decoder circuitry 204 would consider signal chains [ADC+DAC], [DAC+COMP], and [ADC+DAC+PGA] as candidates for qualification. The LUT 205, however, may contain all the foregoing signal chains, and other signal chains using modules not shown in FIG. 1, regardless of whether the environment 100 ever integrates the PGA. Accordingly, the decoder circuitry 204 can use the module availability register 206 to determine which entries within the LUT 205 should currently be considered for qualification. In some examples, the decoder circuitry 204 evaluates the module availability register 206 once per boot cycle to check for the addition or removal of modules from the environment 100.

The decoder circuitry 204 qualifies only some of the signal chains from the subset of LUT 205 entries identified with the module availability register 206. In particular, the decoder circuitry 204 keeps track of which modules have been enabled by the application 104 (e.g., which modules have been utilized by the application 104 as indicated by a high supply voltage in an enable signal) at least once. The decoder circuitry 204 qualifies signal chains where each modules in the ordered sequence has been enabled at least once. Such qualification is beneficial because a signal chain that has been used at least once by an application 104 is likely to be used by the application 104 again. Therefore, the performance and safety of the signal chain should be analyzed with a diagnostic test. In some examples, the decoder circuitry 204 is instantiated by programmable circuitry configured to perform operations such as those represented by the flowchart(s) of FIGS. 5 and 6.

In some applications, providing the control circuitry 202 with unfettered permission to identify qualified signal chains ready for testing and initiate diagnostic tests may lead to an inefficient usage of computational resources (e.g., the modules 110). Accordingly, the example rate determiner circuitry 208 of FIG. 2 provides a diagnostics trigger signal that limits the functionality of control circuitry 202. In some examples, a high supply voltage in the diagnostics trigger signal enables the control circuitry 202 to identify signal chains and initiate diagnostic tests, while a low supply voltage in the diagnostics trigger signal prevents the control circuitry 202 from performing such operations. In some examples, the rate determiner circuitry 208 is instantiated by programmable circuitry configured to perform operations such as those represented by the flowchart(s) of FIGS. 5 and 6.

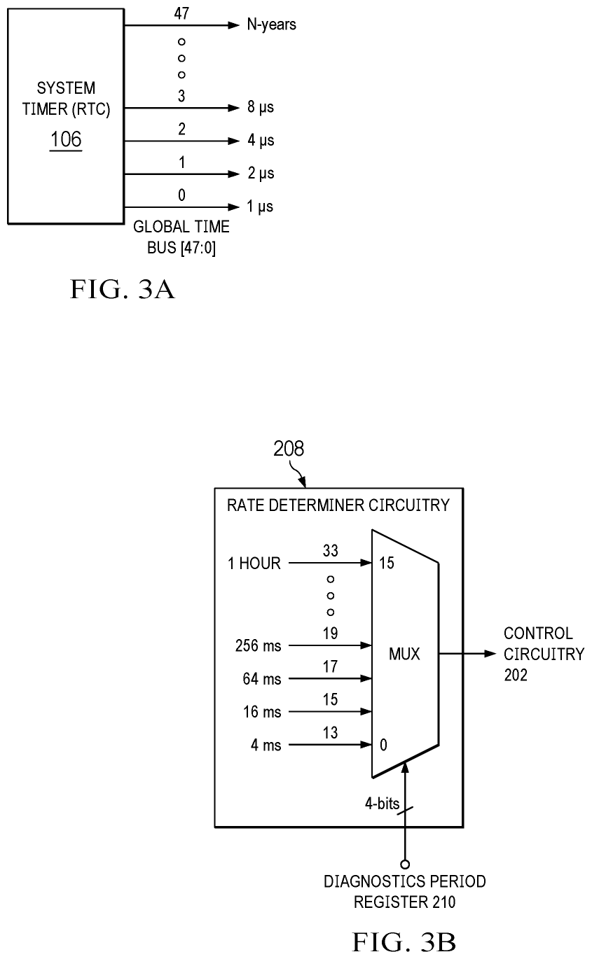

The example rate determiner circuitry 208 uses both the global clock signals from the system timer circuitry 106 and the diagnostics period register 210 to generate the diagnostics trigger. The example diagnostics period register 210 stores configuration data that informs the rate determiner circuitry 208 of the frequency at which the diagnostics trigger signal should be switched between a high supply voltage and a low supply voltage (e.g., the frequency at which the control circuitry 202 switches between enabled and disabled). Advantageously, the frequency information stored in the diagnostics period register 210 may be set by a user and/or the application 104. Accordingly, the user and/or application 104 can balance the utilization of the modules 110 between diagnostic testing and run-time performance by changing the frequency at which the control circuitry 202 is enabled. The rate determiner circuitry 208 is discussed further in connection with FIG. 3B.

In examples described herein, the diagnostic trigger signal alternates between an enabled and disabled state as described above. In such examples, the control circuitry 202 may initiate any number of diagnostic tests when enabled but stops performing tests when disabled. In other examples, a pulse in the diagnostic trigger may indicate the control circuitry 202 is allowed to perform n diagnostic tests, where n is any positive integer. In such an example, the control circuitry 202 cannot perform an (n+1)th diagnostic test until the rate determiner circuitry 208 provides another pulse in the diagnostic trigger signal.

When enabled, the control circuitry 202 further limits the testing of qualified signals chain to those in which each module of the qualified signal chain is currently idle. To initiate a diagnostic test, the control circuitry 202 provides a value in the control input signal to the first module in the signal chain, as described above in connection with FIG. 1. The modules in the signal chain are not idle during the diagnostic test. Rather, the modules in the signal chain are performing operations so that that the last module in the ordered sequence can provide a value in a data signal back to the control circuitry 202.

In some examples, a module in a signal chain sends a value in an activation request signal to the control circuitry 202 while the signal chain is running a diagnostic test. The value informs the control circuitry 202 that the application 104 would like to reclaim the module for use in run-time operations. In such examples, the control circuitry 202 determines whether to return access of the module back to the application 104 before or after an output value in the data signal has been received from the last module in the ordered sequence.

If the control circuitry 202 returns access to the application 104 before receiving the output value, then the application 104 has immediate access to use the requested module in the performance of time sensitive run-time operations. However, the diagnostic test cannot be completed if access is returned to the application 104 before receiving the output value. In such examples, the control circuitry 202 may restart the diagnostic test on the signal chain later (e.g., once all module in the signal chain are once again idle).

Alternatively, if the control circuitry 202 returns access to the module after receiving the output value, the comparison circuitry 214 can use the output value to complete the diagnostic test and produce a pass/fail result. However, if the control circuitry 202 returns access to the module after receiving the output value, there is a lag period between when the application 104 first requests the module and when the application 104 can use the module for run-time operations. In some examples, the lag period may prevent the application 104 from performing certain time sensitive run-time operations.

The control circuitry 202 uses the example policy register 212 of FIG. 2 to determine whether to return access of the module back to the application 104 before or after an output value has been received from the signal chain. The policy register 202 refers to a portion of memory that stores a binary value for each module in the environment 100 (e.g., the modules 110 and any external modules connected to the processor 102). The binary value of a given module describes whether the application 104 wants access to the module as soon as possible or is willing to wait for a lag period (e.g., so that a diagnostic test that includes the module can complete). For example, a value of “True” stored in the policy register 212 in connection with the ADC 110A means that the application 104 wants access to the ADC 110A as soon as possible in the event it reclaims the ADC 110A via the activation signal. In other examples, the value of “True” means that the application 104 is willing to wait to access the ADC 110A until a diagnostic test using the ADC 110A (e.g., [ADC+DAC] or [ADC+DAC+PGA] in the example of FIG. 1) has completed. Accordingly, when the control circuitry 202 receives a value in an activation request from a given module, the control circuitry 202 stops the diagnostic test before receiving the output value if the policy register 202 indicates the application 104 wants access to the module as soon as possible. Similarly, the control circuitry 202 provides access after receiving the output value if the policy register 212 indicates the application 104 will wait for a lag period.

The example comparison circuitry 214 of FIG. 2 receives data signals from the modules 110. Accordingly, if a diagnostic test on a qualified signal chain is not interrupted by the application 104 requesting access to a module as soon as possible, the comparison circuitry 214 receives an output value from the last module in the ordered sequence of the qualified signal chains. The comparison circuitry 214 then compares the output value to an expected value. In some examples, the LUT 205 includes one expected value per signal chain. In other examples, the expected values that correspond to possible signal chains are stored elsewhere in a memory of the environment 100.

The comparison circuitry 214 provides a result of “pass” to the application 104 if the output value matches the expected value or is within a threshold range of the expected value. In examples herein, the foregoing result may be referred to as a qualified signal chain passing the diagnostic test. Alternatively, the comparison circuitry 214 provides a result of “fail” to the application 104 if the output value is outside of a threshold range that is centered on the expected value. In examples herein, the foregoing result may be referred to as a qualified signal chain failing the diagnostic test.

If the qualified signal chain fails the diagnostic test, the comparison circuitry 214 may additionally provide an abort instruction to the application 104. As used herein, an abort instruction refers to a signal that forces the application 104 to stop the performance of one or more run-time operations. In some examples, the comparison circuitry 214 provides the abort instruction if the failure of the qualified signal chain is indicative of a safety issue. For example, some failures may indicate that one or more of the modules 110 could be damaged if run-time operations continue. Additionally or alternatively, some failures may indicate that one or more of the modules 110 are producing unexpected outputs that, if relied upon by the application 104 at run-time, could cause the application 104 to produce an unsafe result.

The example abort register 216 of FIG. 2 is an amount of memory that indicates which failed diagnostic tests should produce an abort instruction. The abort register may include one binary value per signal chain in the LUT 205. In some examples, a “True” value in the abort register 216 associated with a given signal chain (e.g., [ADC+DAC]) indicates that an abort instruction should be provided to the application 104 if the signal chain fails a diagnostic test. In some examples, the comparison circuitry 214 is instantiated by programmable circuitry configured to perform operations such as those represented by the flowchart(s) of FIGS. 5 and 6.

FIG. 3A is a block diagram of an example implementation of the system timer of FIG. 1. FIG. 3A shows that the system timer circuitry 106 can produce global clock signals at a variety of different frequencies. For example, the signal with index zero transmits a pulse once per microsecond. That is, the signal of index zero has a frequency of 1 Mega Hertz (MHz). The signal at index one transmits a pulse once every two microseconds (e.g., with a frequency of 500 kilo Hertz (kHz)). In the example of FIG. 3A, the global time bus includes 48 signals where a signal with index n transmits pulses at half the frequency of a signal with index (n−1). Accordingly, the system timer circuitry 106 produces a signal at index 47 with an approximate frequency of 7.1e-15 Hz (e.g., a pulse is sent approximately once every 4.46 years). In other examples, the system timer circuitry 106 generates a different number of clock signals and/or generates clock signals with different frequencies.

FIG. 3B is a block diagram of an example implementation of the rate determiner circuitry 208 of FIG. 2. The rate determiner circuitry 208 includes multiplexer circuitry to select one signal from the global time bus to serve as the rate determiner signal (e.g., to provide pulses that enable or disable the control circuitry 202). The multiplexer circuitry determines which signal to pass to the control circuitry 202 based on the diagnostics period register 210. The passed signal may indicate the periodicity at which the diagnostic test will be performed when the modules 110 are idle. For example, a faster diagnostics rate can be used for compliance with higher safety levels. In the example of FIGS. 3A and 3B, the diagnostics period register 210 includes four bits and can therefore indicate a selection between one of 16 possible inputs. Accordingly, the multiplexer circuitry of this example connects to a subset of signals available on the global time bus (e.g., the signals ranging in frequency between once pulse per four milliseconds and one pulse per hour) and provides one signal from the subset to the control circuitry 202 to enable diagnostic testing. In other examples, the multiplexer circuitry 3B may connect to a different subset of signals from the global time bus and/or connect to a different number of signals form the global time bus. Similarly, in other examples, the diagnostic period register 210 may include any number of bits.

FIG. 4 are block diagrams of example implementations of signal chains. FIG. 4 includes example configurations 402, 404, and 406. To obtain an output value from the last module of a qualified signal chain, the modules 110 must connect to one another in a specific configuration (e.g., in an ordered sequence) to properly implement the signal chain. Accordingly, the example control circuitry 202 uses the control input signals to provide both: a) an input value to the first module in the ordered sequence, and b) instructions regarding where a given module in the chain should transmit an output value to.

For example, the configurations 402 show how components within the processor 102 of FIG. 1 would connect to one another to test the signal chain [DAC+ADC]. To implement the configuration 402, the control circuitry 202 in the HSDE circuitry 108 selects the output of DAC 110B as input to the ADC 110A. Both the DAC 110B and the ADC 110A operate on different reference voltages from the VREF circuitry 112 to avoid common cause errors. The control circuitry 202 provides a known value as the input word to the DAC 110B and instructs the DAC 110B to provide the analog output to the ADC 110A. The HSDE circuitry 108 also instructs the ADC 110A to provide its converted, digital output to the HSDE circuitry 108 so the comparison circuitry 214 can check the value with a threshold window to declare a diagnostic pass/fail result.

The example configurations 404 show how components within the processor 102 would connect to one another to test the signal chain [DAC+COMP]. To implement the configuration 404, the control circuitry 202 in the HSDE circuitry 108 selects the output of the DAC 110B as an input to the COMP 110D. The control circuitry 202 also provides a known reference input from the VREF circuitry 112 as the other input to the COMP 110D. The control circuitry 202 provides an input word to the DAC 110B such that the output voltage can trigger a change in the output of the COMP 110D. The output of the HSDE circuitry 108 checks the output of the COMP 110D to declare diagnostic pass/fail result.

The example configuration 406 show how components within the processor 102 would connect to one another to test the signal chain [DAC+PGA+ADC]. To implement the configuration 406, the HSDE circuitry 108 selects the output of the DAC 110B as an input to the PGA 110C. Both the DAC 110B and the ADC 110A operate on different reference voltages from the VREF circuitry 112 to avoid common cause errors. The control circuitry 202 sets the input of the DAC 110B to a known value. The control circuitry 202 then compares the output of the ADC 110A to the DAC 110B input word as adjusted by the gain setting of PGA 110C.

While an example manner of implementing the HSDE circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the control circuitry 202, the decoder circuitry 204, the LUT 205, the module availability register 206, the rate determiner circuitry 208, the diagnostics period register 210, the policy register 212, the comparison circuitry 214, the abort register 216 of FIG. 2, may be implemented by hardware alone or by hardware in combination with software and/or firmware. Thus, for example, any of the control circuitry 202, the decoder circuitry 204, the LUT 205, the module availability register 206, the rate determiner circuitry 208, the diagnostics period register 210, the policy register 212, the comparison circuitry 214, the abort register 216 of FIG. 2, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example HSDE circuitry 108 may include one or more elements, processes, and/or devices in addition to, or instead of, those illustrated in FIG. 2, and/or may include more than one of any or all of the illustrated elements, processes and devices.

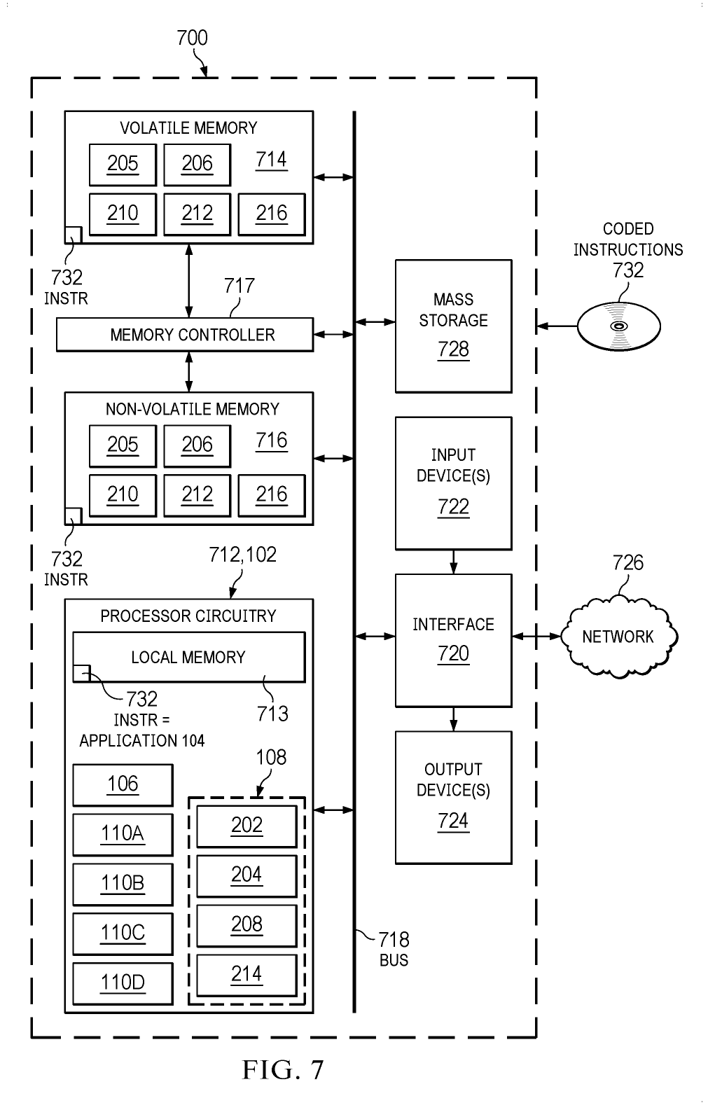

Flowchart(s) representative of example operations which may be performed by programmable circuitry to implement and/or instantiate the HSDE circuitry of FIG. 2, are shown in FIGS. 5 and 6. The example operations may be executed by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

Further, although the example program is described with reference to the flowchart(s) illustrated in FIGS. 5 and 6, many other methods of implementing the example HSDE circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

FIG. 5 is a flowchart representative of example operations that may be executed, instantiated, and/or performed using an example programmable circuitry implementation of the HSDE circuitry 108 of FIG. 1. The example operations 500 of FIG. 5 begin when the decoder circuitry 204 determine which signal chains are testable in the example environment 100 of FIG. 1. (Block 502). To do so, the decoder circuitry 204 uses the module availability register 206 to identify which signal chains in the LUT 205 only contain modules that are implemented in the environment 100 (e.g., implemented within or connected to the processor 102). In some examples, the decoder circuitry 204 implements block 502 once per boot cycle to identify if any modules were connected to the processor 102 while the processor was powered off.

The example decoder circuitry 204 continuously identifies signal chains enabled by the application 104. (Block 504). The identification of a signal chain at block 504 may be referred to as qualifying a signal chain. For example, the decoder circuitry 204 qualifies a signal chain in response to a determination that the enable signals indicate each module in the signal chain has been utilized by the application 104 at least once during run-time. In some examples, the decoder circuitry 204 implements block 504 continuously and in parallel with the implementation of blocks 506-516. Accordingly, the decoder circuitry 204 may qualify a second signal chain while the control circuitry 202 is running a diagnostic test on a first signal chain that was previously qualified.

The control circuitry 202 determines whether the diagnostic trigger signal has enabled testing. (Block 506). In some examples, a high supply voltage in the diagnostic trigger signal indicates the control circuitry 202 is enabled and permitted to perform diagnostic testing. Similarly, in such examples, a low supply voltage in the diagnostic trigger signal indicates the control circuitry 202 is disabled and prevented from performing diagnostic testing. The diagnostic trigger signal switches between enabling and disabling the control circuitry 202 at a frequency based on the diagnostics period register 210. In turn, the value stored in the diagnostics period register 210may be determined by a user and/or the application 104.

If the diagnostics trigger signal has disabled testing (Block 506: No), the control circuitry 202 determines whether the processor 102 has been turned off. (Block 508). If the processor 102 has been turned off (Block 508: Yes), the example operations 500 end. Alternatively, if the processor 102 is still powered on (Block 508: No), the control circuitry 202 waits for a period (Block 510) before control returns to block 506.

The rate determiner circuitry 208 changes the value of the diagnostic trigger signal independently of the status of the control circuitry 202. Accordingly, if the diagnostic trigger signal changes to disabled during the execution of blocks 512-516, control proceeds directly to block 510 instead of following the sequence described below. That is, in response to being disabled by the diagnostics trigger signal, the control circuitry 202 may stop any operations to perform a diagnostic test and wait to be re-enabled before proceeding.

If the diagnostics trigger signal has enabled testing (Block 506: Yes), the control circuitry 202 selects a qualified signal chain. (Block 512). The control circuitry 202 may select one qualified signal chain from a set using any suitable technique. In some examples, the control circuitry 202 selects qualified signal chains using round robin scheduling. In other examples, the control circuitry 202 selects a signal chain based on a prioritization scheme (e.g., based on the amount of time a signal chain has been qualified without a completed diagnostic test, based on the number of operations in the corresponding diagnostic test, etc.). The control circuitry 202 may be configured to select a signal chain in response to determining that the signal chain is the only signal chain that is currently idle. In some examples, the control circuitry 202 may select a qualified signal chain even if the signal chain has already completed a diagnostic test earlier in run-time.

The control circuitry 202 checks whether all modules in the selected signal chain are currently idle. (Block 514). If one or more of the modules in the selected signal chain are not currently idle (Block 514: No), control returns to block 512 where the control circuitry 202 selects another qualified signal chain. The control circuitry 202 skips the selected signal chain in such an example because at least one module is performing operations for an application and is therefore unable to participate in a diagnostic test. Furthermore, skipping a first qualified signal chain enables the control circuitry 202 to test a second qualified signal chain while simultaneously waiting for the application to finish using one or more modules in the first signal chain.

If all modules in the selected signal chain are currently idle (Block 514: Yes), the control circuitry 202 and the comparison circuitry 214 diagnose the selected signal chain. (Block 516). The control circuitry 202 and the comparison circuitry 214 can diagnose the selected signal chain by running a diagnostic test. Block 516 is discussed further in connection with FIG. 6.

The flowchart of FIG. 5 describe example operations 500 that are performed in reference to a single application 104. In some examples, the HSDE circuitry 108 runs diagnostic tests while multiple applications are utilizing the modules 110 in an interleaved fashion (e.g., in a multi-threading use case). In such examples, the decoder circuitry 204 may keep separate lists of qualified signal chains at block 504 for each application running on the processor 102. Similarly, the modules 110 are only idle in such an example if they are not being utilized by any of the applications running on the processor 102. Accordingly, the frequency at which the control circuitry 202 may perform diagnostic tests at block 516 may depend on the number of applications running concurrently.

In some examples, the qualification of signals by the decoder circuitry 204 is application-specific so that the HSDE circuitry 108 limits diagnostic testing to signal chains that are actively being used. Such a limitation is advantageous because signal chains that are theoretically capable of implementation pose less of a potential safety risk than signal chains that actively being used at run-time.

In some examples, execution of the application 104 stops and execution of another application begins before the processor 102 is powered off at block 508. In such examples, the decoder circuitry 204 may create a new set of qualified signal chains at block 504 based on the other application that has begun execution. By doing so, the HSDE circuitry 108 may prevent a qualified signal from the application 104 being tested after execution of the application 104 has stopped.

FIG. 6 is a flowchart representative of example machine readable instructions and/or example operations that may be executed, instantiated, and/or performed using example programmable circuitry to diagnose a selected signal chain as discussed in connection with FIG. 5. In particular, the flowchart of FIG. 6 is an example implementation of block 516 of FIG. 5.

Execution of block 516 begins when the example control circuitry 202 of FIG. 2 initializes a diagnostic test. (Block 602). To initialize the diagnostic test, the control circuitry 202 provides a value in the control input signal to the first module in the ordered sequence of the signal chain. Examples of such input values are discussed above in connection with FIG. 4. After initializing the diagnostic test, the control circuitry 202 implements block 604 and block 616 concurrently (e.g., in parallel with one another).

The control circuitry 202 determines whether the modules in the signal chain have completed the operations that form the diagnostic test. (Block 604). If the operations are still in progress (Block 604: No), the control circuitry 202 waits for a period (Block 606) before control returns to block 604.

Alternatively, if the modules have completed the operations that form the diagnostic test (Block 604: Yes), the comparison circuitry 214 compares the output of the signal chain to an expected value. (Block 608). The comparison may produce a result of “pass” or “fail” depending on whether the output value is within a threshold range of the expected value (e.g., whether the output value is within expected value±threshold value.

The comparison circuitry 214 reports the result of the comparison to the application 104. (Block 610). The comparison circuitry 214 then determines whether the result is indicative of a safety issue (Block 612). To perform the determination of block 612, the comparison circuitry 214 checks the abort register 216 when a signal chain fails a diagnostic test.

If the result of the diagnostic test is not indicative of a safety issue (Block 612: No), control returns to block 510 of FIG. 5. Alternatively, if the result of the diagnostic test is indicative of a safety issue (Block 612: Yes), the comparison circuitry 214 provides an abort instruction to the application. (Block 614). In some examples, the abort instruction forces the application 104 to stop the performance of one or more run-time operations. Control returns to block 510 of FIG. 5 after block 614.

In parallel with block 604, the control circuitry 202 determines whether the application 104 has requested access to a module in the signal chain. (Block 616). To do so, the control circuitry 202 may continuously monitor the activation request signals provided by the modules 110 while the control circuitry 202 is enabled. If the application 104 has not requested access to any of the modules in the signal chain (Block 616: No), the control circuitry 202 waits for a period (block 618) before control returns to block 616.

Alternatively, if the application 104 has requested access to a module in the signal chain (Block 616: Yes), the control circuitry 202 determines whether the application 104 will wait for the diagnostic test to finish. (block 620). The control circuitry 202 performs the determination by checking the policy register 212 to identify the module-specific policy of the application. In examples where the application 104 requests multiple modules from the signal chain concurrently at block 616, the application 104 will only wait for the diagnostic test to finish if none of policies in the policy register 212 that correspond to the requested modules indicate the application 104 wants the module as soon as possible.

If the application 104 will wait for the diagnostic test to finish (Block 620: Yes), control returns to block 604 where the control circuitry 202 determines if the operations that form the diagnostic test have been completed. Alternatively, if the application 104 will not wait for the diagnostic test to finish (Block 620: No), control returns to block 510 of FIG. 5. By returning to waiting for a diagnostic trigger (block 510) when the application 104 will not wait for the diagnostic test to finish (Block 620: No), the HSDE circuitry 108 relinquishes control of the modules in the signal chain and returns access to the application 104.

The control circuitry 202 implements blocks 604-614 in parallel with and independently from blocks 616-620. Accordingly, in some examples, operations from blocks 616-620 may control to return to block 510 (thereby stopping the diagnostic test) before the diagnostic test completes. Advantageously, the example operations 500 enables: a) the application 104 to use the modules 110 to perform run-time operations whenever needed, and b) the HSDE circuitry 108 to perform diagnostic tests independently from the application 104 during interim periods.

FIG. 7 is a block diagram of an example programmable circuitry platform 700 structured to execute and/or instantiate the example machine-readable instructions and/or the example operations of FIGS. 5 and 6 to implement the HSDE circuitry of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. The programmable circuitry 712 may include more than one processor in some examples. In this example, the programmable circuitry 712 implements the system timer circuitry 106, the modules 110, the control circuitry 202, the decoder circuitry 204, the rate determiner circuitry 208, the comparison circuitry 214, and more generally, the processor 102. In some examples, the HSDE 108 and circuitry 202, 204, 208, and 214 may be separate from and coupled to programmable circuitry 712. In such examples, HSDE 108 can include any of the circuitry attributed to programmable circuitry 712, such as one or more integrated circuits, logic circuits, FPGAs, microprocessors, CPUs, GPUs, DSPs, and/or microcontrollers.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716. In this example, the main memory 714, 716 implements the LUT 205, the module availability register 206, the diagnostic period register 210, the policy register 212, and the abort register 216.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented application 104, may be stored in the mass storage device 728, in the volatile memory 714, in the non-volatile memory 716, and/or on at least one non-transitory computer readable storage medium such as a CD or DVD which may be removable.

The example application 104 may be implemented using executable instructions (e.g., computer readable and/or machine-readable instructions) that form an executable program. The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example application 104 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible in the described embodiments, and other embodiments are possible, within the scope of the claims.

From the foregoing, it will be appreciated that example systems, apparatus, articles of manufacture, and methods have been described that implement safety diagnostics. Described systems, apparatus, articles of manufacture, and methods improve the efficiency of using a computing device by implement a hardware safety diagnostics engine to perform diagnostic tests that is application context aware, time, cost, and power efficient, software agnostic, helps ensure safety, and can be performed at run-time. Described systems, apparatus, articles of manufacture, and methods are accordingly directed to one or more improvement(s) in the operation of a machine such as a computer or other electronic and/or mechanical device.

What is claimed is:

1. An apparatus to implement safety diagnostics, the apparatus comprising:
interface circuitry coupled to a plurality of circuit modules; and
diagnostic circuitry configured to:
determine a set of signal chains that may be used by programmable circuitry, wherein a first signal chain in the set of signal chains includes one or more circuit modules of the plurality of circuit modules;
identify the first signal chain was used by the programmable circuitry; and
run a diagnostic test on the first signal chain via the interface circuitry in response to a determination that the one or more circuit modules in the first signal chain are idle.

2. The apparatus of claim 1, wherein to run the diagnostic test, the diagnostic circuitry is configured to:
provide an input to a first circuit module in the first signal chain;
obtain an output from a last circuit module in the first signal chain; and
compare the output to an expected value.

3. The apparatus of claim 1, wherein the diagnostic circuitry is configured to identify the first signal chain in response to receiving a pulse in a trigger signal.

4. The apparatus of claim 1, wherein:
The circuit modules are first circuit modules; and
the diagnostic circuitry is configured to:
access a list of signal chains, the list including signal chains that describe second circuit modules separate from the apparatus; and
determine the set of signal chains that may be used by the programmable circuitry by identifying signal chains within the list that exclude the second circuit modules.

5. The apparatus of claim 1, wherein:
the first signal chain includes a first circuit module; and
the diagnostic circuitry is configured to:
receive, while running the diagnostic test, a request from the programmable circuitry to access the first circuit module; and
provide access to the first circuit module to the programmable circuitry after the diagnostic test is completed.

6. The apparatus of claim 5, wherein the diagnostic circuitry is configured to:
determine, based on a policy register in memory, the programmable circuitry will wait to access the first circuit module until the diagnostic test is completed; and
provide access to the first circuit module based on the determination.

7. The apparatus of claim 1, wherein:
the first signal chain includes a first circuit module; and
the diagnostic circuitry is configured to:
receive, while running the diagnostic test, a request from the programmable circuitry to access the first circuit module; and
provide access to the first circuit module to the programmable circuitry before the diagnostic test is completed.

8. An apparatus to implement safety diagnostics, the apparatus comprising:
programmable circuitry;
a plurality of circuit modules; and
diagnostic circuitry configured to:
determine a set of signal chains that may be used by the programmable circuitry, wherein a first signal chain in the set of signal chains includes one or more circuit modules of the plurality of circuit modules;
identify the first signal chain was used by the programmable circuitry;
run a diagnostic test on the first signal chain in response to a determination that the one or more circuit modules in the first signal chain are idle; and
provide a result of the diagnostic test to the programmable circuitry.

9. The apparatus of claim 8, wherein the diagnostic circuitry is configured to identify the first signal chain in response to receiving a pulse in a trigger signal.

10. The apparatus of claim 8, wherein:
the plurality of circuit modules are a first plurality of circuit modules;
the apparatus further includes memory to store a list of signal chains, the list including signal chains that describe a second plurality of circuit modules separate from the apparatus; and
to determine the set of signal chains that may be used by the programmable circuitry, the diagnostic circuitry is configured to identify signal chains within the list that exclude the second plurality of circuit modules.

11. The apparatus of claim 8, wherein the plurality of circuit modules include one or more of an analog to digital converter (ADC), a digital to analog converter (DAC), a programmable gain amplifier, and a comparator.

12. The apparatus of claim 8, wherein the plurality of circuit modules include an Intellectual Property (IP) core that executes machine-readable instructions.

13. The apparatus of claim 8, wherein:
the first signal chain includes a first circuit module; and
the diagnostic circuitry configured to:
receive, while running the diagnostic test, a request from the programmable circuitry to access the first circuit module; and
provide access to the first circuit module to the programmable circuitry after the diagnostic test is completed.

14. The apparatus of claim 13, wherein the diagnostic circuitry is configured to:
determine, based on a policy register in memory, the programmable circuitry will wait to access the first circuit module until the diagnostic test is completed; and
provide access to the first circuit module based on the determination.

15. The apparatus of claim 8, wherein:
the first signal chain includes a first circuit module; and
the diagnostic circuitry configured to:
receive, while running the diagnostic test, a request from the programmable circuitry to access the first circuit module; and
provide access to the first circuit module to the programmable circuitry before the diagnostic test is completed.

16. The apparatus of claim 8, wherein the diagnostic circuitry is configured to run the diagnostic test on the first signal chain while other circuit modules in the apparatus implement instructions from the programmable circuitry.

17. A method to implement safety diagnostics, the method comprising:
determining, with diagnostic circuitry, a set of signal chains that may be used by programmable circuitry, wherein a first signal chain in the set of signal chains includes one or more circuit modules;
identifying, with the diagnostic circuitry, the first signal chain was used by the programmable circuitry; and
running a diagnostic test on the first signal chain with the diagnostic circuitry and in response to a determination that the one or more circuit modules in the first signal chain are idle.

18. The method of claim 17, further including identifying the first signal chain in response to receiving a pulse in a trigger signal.

19. The method of claim 17, wherein:
the circuit modules are first circuit modules; and
the method further includes:
accessing a list of signal chains, the list including signal chains that describe second circuit modules separate from the diagnostic circuitry; and
determining the set of signal chains that may be used by the programmable circuitry by identifying signal chains within the list that exclude the second circuit modules.

20. The method of claim 17, wherein:
the first signal chain includes a first circuit module; and
the method further includes:
receiving, while running the diagnostic test, a request from the programmable circuitry to access the first circuit module;
determining, based on a policy register in memory, the programmable circuitry will wait to access the first circuit module until the diagnostic test is completed; and
providing, based on the determination, control of the first circuit module to the programmable circuitry after the diagnostic test is completed.
